(19) United States
(12) Patent Application Publication
(10) Pub. No.: US 2008/0139221 A1
(43) Pub. Date: Jun. 12, 2008

(54) System for providing address using geocoding application programming interface in open service platform

(75) Inventors: Hyun Kyung Yoo, Daejeon-city (KR); Sang Ki Kim, Daejeon-city (KR)

Correspondence Address: BLAKELY SOKOLOFF TAYLOR & ZAFMAN, 1279 OAKMEAD PARKWAY, SUNNYVALE, CA, 94085-4040, US

(73) Assignee: Electronics and Telecommunications Research Institute

(21) Appl. No.: 11/981,908

(22) Filed: Oct. 31, 2007

(30) Foreign Application Priority Data
Dec. 8, 2006 (KR) 10-2006-0125129

(51) Int. Cl. H04Q 7/20

(52) U.S. Cl. 455/456.2

(57) ABSTRACT

A system for providing an address using a geocoding application programming interface (API) in an open service platform and a method thereof are provided. The system includes an application server which performs an address service and a function of a web server, a location information server which provides location information of a mobile terminal, an address server which provides the address information corresponding to the location information, and a service gateway which accesses the location information server and the address server in order to provide the address information to the application server according to a request of the application server. Since a telecommunication carrier has a location information server and an address server, a gateway and an application server can communicate with each other using a standard geocoding API. The address server performs mapping of the location received from the location information server to the corresponding address, and the gateway transmits the address to the application server. Accordingly, even though a service provider need not have the address server, the service provider can provide the information received from the gateway to a user.

### CROSS-REFERENCE TO RELATED PATENT APPLICATION

This application claims the benefit of Korean Patent Application No. 10-2006-0125129, filed on Dec. 8, 2006, in the Korean Intellectual Property Office, the disclosure of which is incorporated herein in its entirety by reference.

### BACKGROUND OF THE INVENTION

1. Field of the Invention

The present invention relates to a gateway for providing an address service capable of being used efficiently in a mobile communication network using a geocoding application programming interface (API), a system including the gateway, and a method thereof, and more particularly, to a gateway for obtaining location (coordinates of longitude and latitude) information of a terminal from a location information server, obtaining an address corresponding to the location from an address server, and transmitting the resulting address to the application server which requests the address service, a system including the gateway, and a method thereof. This work was supported by the IT R&D program of MIC/IITA[2005-S-056-02, Development of Open API and Service Platform Technologies].

2. Description of the Related Art

Conventionally, every service provider that provides a location information service includes an address server. When a gateway obtains a location corresponding to a mobile terminal number from a location information server and transmits the location to an application server, the application server needs to provide an address, which is obtained by performing mapping of the transmitted location to the address, to the terminal that requests the service. However, the operations of the application server are complicated.

### SUMMARY OF THE INVENTION

The present invention provides a gateway capable of allowing a service provider to provide various location and address services by using a location information server and an address server of a telecommunication carrier and allowing the service provider the use of a function of a communication network, a system including the gateway, and a method thereof.

According to an aspect of the present invention, there is provided a gateway which provides an address using a geocoding API (application programming interface) in an open service platform, comprising: a terminal address web module which is connected to an application server; a main module which performs main processing and has a function of an RMI (remote method invocation) server; a terminal address management unit which performs a geocoding function; and a location management unit which obtains location information and address information of a mobile terminal according to a request from the terminal address management unit to provide the information to the application server.

According to another aspect of the present invention, there is provided an open service system which provides an address using a geocoding API (application programming interface) in an open service platform, comprising: an application server which performs a logic operation of an address service and performs a function of a web server; a location information server which provides location information of a mobile terminal; an address server which provides address information corresponding to the location information; and a service gateway which accesses the location information server and the address server to provide the address information to the application server according to a request from the application server.

### BRIEF DESCRIPTION OF THE DRAWINGS

The above and other features and advantages of the present invention will become more apparent by describing in detail exemplary embodiments thereof with reference to the attached drawings in which:

FIG. 1 is a view showing a configuration of a system which provides an address using a geocoding application programming interface (API) in an open service platform according to an embodiment of the present invention;

FIG. 2 is a block diagram of a gateway of the system which provides the address using the geocoding API in the open service platform;

FIG. 3 illustrates a flow of messages associated with a function of providing an address of one terminal in a method of providing the address using the geocoding API in the open service platform;

FIG. 4 illustrates a flow of messages associated with a function of providing addresses of a group of terminals in the method of providing the address using the geocoding API in the open service platform; and

FIG. 5 illustrates a flow of messages associated with a function of providing a distance between a terminal and an address in the method of providing the address using the geocoding API in the open service platform.

### DETAILED DESCRIPTION OF THE INVENTION

Hereinafter, the present invention will be described in detail by explaining exemplary embodiments of the invention with reference to the attached drawings.

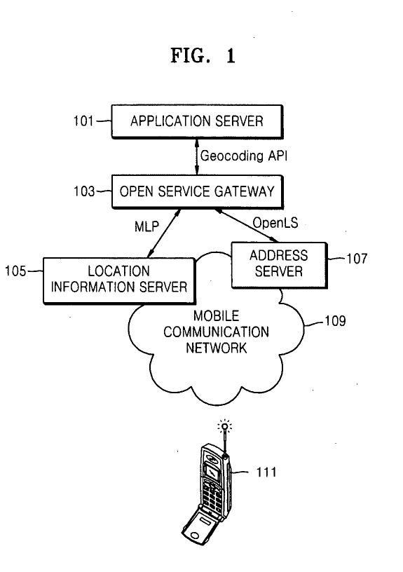

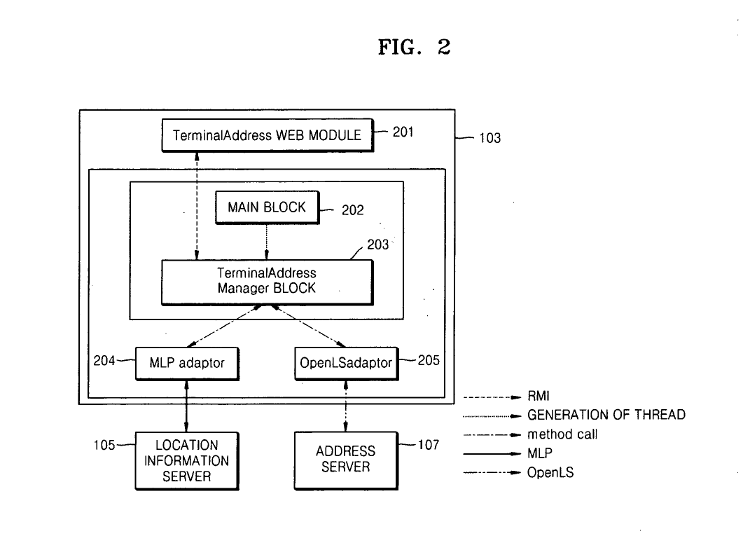

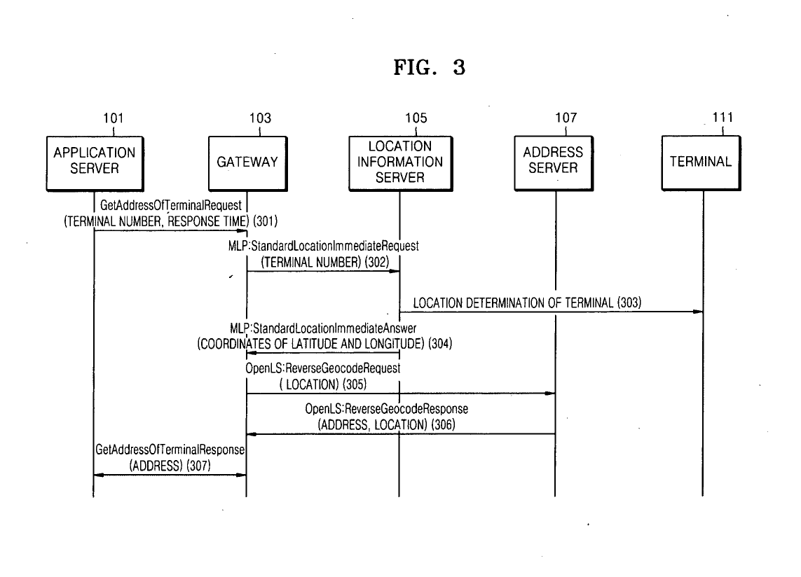

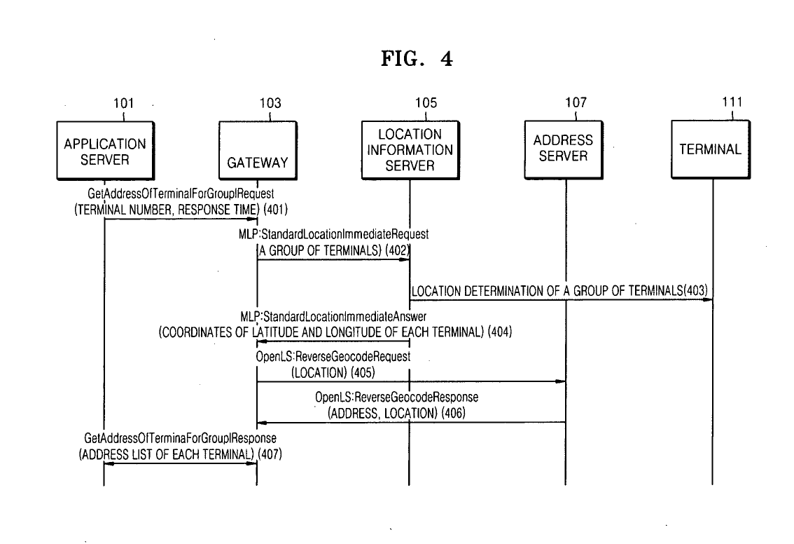

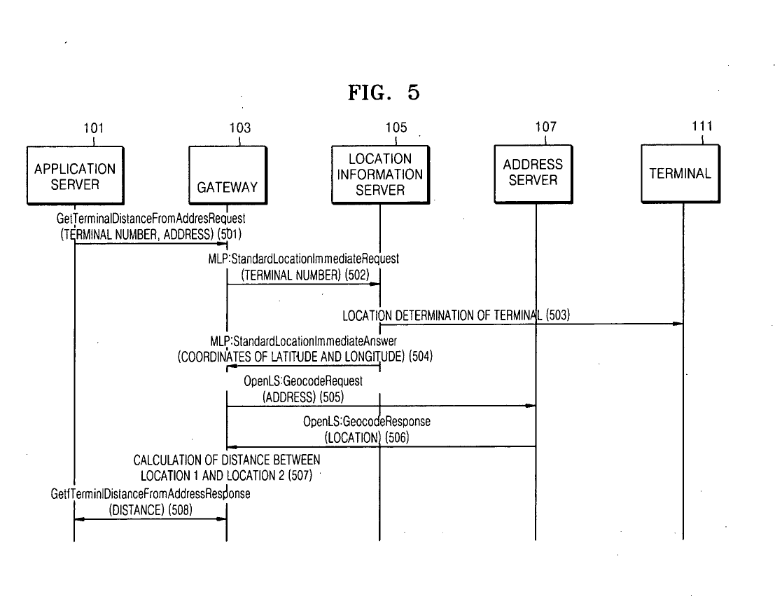

FIG. 1 is a view showing a configuration of a system which provides an address using a geocoding application programming interface (API) in an open service platform according to an embodiment of the present invention. FIG. 2 is a block diagram of a gateway of the system which provides the address using the geocoding API in the open service platform. FIG. 3 illustrates a flow of messages associated with a function of providing an address of one terminal in a method of providing the address using the geocoding API in the open service platform. FIG. 4 illustrates a flow of messages associated with a function of providing addresses of a group of terminals in the method of providing the address using the geocoding API in the open service platform. FIG. 5 illustrates a flow of messages associated with a function of providing a distance between a terminal and an address in the method of providing the address using the geocoding API in the open service platform.

Referring to FIG. 1, the system according to an embodiment of the present invention includes an application server 101, an open service gateway 103, a mobile communication network 109, a location information server 105 in the mobile communication network, an address server 107, and a mobile terminal 111 of which a location and address are to be determined. The gateway 103 and the location information server (sometimes, referred to as a mobile positioning center (MPC)) 105 communicate with each other using a mobile location protocol (MLP). The gateway 103 and the address server 107 exchange messages with each other using an openGIS location service (OpenLS).

The gateway 103, which provides a geocoding web service, is constructed as shown in FIG. 2 to perform conversion between a terminal number and a location and address of the terminal. A TerminalAddress web module 201 functions as an interface to the application server 101. A main block 202 functions as a main processor and a remote method invocation (RMI) server. A TerminalAddressManager block 203 performs a geocoding function. The gateway 103 includes an MLP adaptor 204 and an OpenLS adaptor 205. In response to a request of the TerminalAddressManager block 203, the MLP adaptor 204 requests the location information server 105 for the location information of the terminal and receives the response from the location information server 105. In response to a request of the TerminalAddressManager block 203, the OpenLS adaptor 205 requests the address server 107 for the address information corresponding to the location of the terminal and receives the response from the address server 107.

As a web module which performs the geocoding web service, the TerminalAddress web module 201 processes a message of a simple object access protocol (SOAP) and transmits a request from the application server to a RMI server. As a main thread functioning as a main processor, the main block 202 generated the RMI server for processing a request of an RMI from the TerminalAddress web module 201 and registered the RMI server in a RMI registry. Also, the main block 202 allows the MLP adaptor 204 and the OpenLS adaptor 205 to operate. In response to a request of the TerminalAddress web module 201, the RMI server searches for an instance of the TerminalAddressManager block 203. The TerminalAddressManager block 203 is generated by the RMI server. The TerminalAddressManager block 203 receives a one-time request and returns one-time status information. As a functional block for obtaining coordinates of latitude and longitude of the mobile terminal, the MLP adaptor 204 together with the location information server 105 is operated by the MLP. As a functional block for obtaining the address information corresponding to the location information (the coordinates of latitude and longitude), the OpenLS adaptor 205 together with the address server 107 is operated by the OpenLS.

The geocoding API can be practically used in the service for obtaining an address of one or a group of mobile terminals and the service for obtaining a distance between a mobile terminal and a specific address. The service for obtaining the address information of one terminal is performed by using a GetAddressOfTerminal operation. The service for obtaining the address information of a group of terminals is performed by using a GetAddressOfTerminalForGroup operation. The service for obtaining the distance between the terminal and the specific address is performed by using a GetTerminalDistanceFromAddress operation.

The GetAddressOfTerminal operation is described with reference to FIG. 3 illustrating a flow of messages between the application server 101, the gateway 103, the location information server 105, the address server 107, and the mobile terminal 111. The GetAddressOfTerminal operation has a function of obtaining the address of one terminal.

When a user who wants to use the address service requests the application server 101 for an address of a terminal by using a short messaging service (SMS), a multimedia messaging service (MMS), or a wireless application protocol (WAP) in a mobile terminal of the user, the application server 101 calls a geocoding web service and transmits a GetAddressOfTerminalRequest message to the gateway 103 in operation 301. The gateway 103 performs mapping of a GetAddressOfrerminalRequest message to an MLP StandardLocationimmediateRequest message and transmits the MLP StandardLocationImmediateRequest message to the location information server 105 in operation 302.

The location information server 105 requests a sub-network for location determination of the terminal in operation 303. The location information server 105 transmits the result of the location determination to the gateway 103 by using a StandardLocationImmediateAnswer message in operation 304. The gateway 103 transmits the location of the terminal to the address server 107 by using a ReverseGeocoderRequest message in operation 305. The gateway 103 obtains the address corresponding to the location of the terminal by using a ReverseGeocoderResponse message in operation 306. The gateway 103 transmits an AddressInfo type of address to the application server 101 by using a GetAddressOfTerminalResponse message in operation 307. Here, the AddressInfo type of address includes information on a nation, a province/municipality, a county, a city, a street, an address number, additional information, and a zip code. The application server 101 transmits the address information of the terminal to the terminal of a user who requests the service.

Referring to FIG. 4, a flow of messages in a GetAddressOfTerminalForGroup operation is the same as that of the GetAddressOfTerminal operation except that a plurality of terminal numbers are used. The GetAddressOfTerminalForGroup operation has a function of obtaining the addresses of a group of the terminals.

When the user requests an address list of a group of the mobile terminals, the application server 101 calls a GetAddressOfTerminalForGroupRequest message in operation 401. The gateway 103 obtains the address of each terminal by using a StandardLocationImmediateRequest message in operation 402, a StandardLocationImmediateAnswer message in operations 403 and 404 by the MLP, and a ReverseGeocoderRequest message in operation 405 and a ReverseGeocoderResponse message in operation 406 by the OpenLS. The gateway 103 transmits an AddressData type of address to the application server 101 by using a GetAddressOfTerminalForGroupResponse message in operation 407. The AddressData type of address includes a terminal number and an AddressInfo type of address. The application server transmits the address information to the terminal of the user who requests the service.

A flow of messages in a GetTerminalDistanceFromAddress operation is described with reference to FIG. 5. The GetTerminalDistanceFromAddress operation has a function of obtaining a distance between a terminal and a specific address. According to this operation, the location information server 105 and the address server 107 convert a terminal number and an address as parameters of a service request message to their own locations, and the gateway 103 calculates the distance between the two locations. In order to provide this service, when a user requests the service for obtaining the distance between a terminal and a specific address, the application server 101 calls a GetTerminalDistanceFromAddressRequest message in operation 501. The gateway 103 transmits a StandardLocationImmediateRequest message to the location information server 105 in operation 502 and requests the location of the terminal. When the location information server 105 requests a sub-network for location determination of the terminal in operation 503, the location information server 105 transmits the result of the location determination to the gateway 103 by using a StandardLocationImmediateAnswer message in operation 504. In addition, the gateway 103 transmits a specific address to the address server 107 by using a GeocoderRequest message in operations 505, and then the gateway 103 obtains the location corresponding to the specific address by using a GeocoderResponse message in operation 506. Then, the gateway 103 calculates the distance between the two locations in operation 507 and transmits the resulting distance to the application server 101 by using a GetTerminalDistanceFromAddressResponse message. The application server 101 transmits the distance to the terminal of a user who requests the service in operation 508.

In a conventional model for providing a location service including a Terminal Location function of Parlay X, each service provider has an application server and an address server. The application server receives coordinates of latitude and longitude of a terminal from a location information server through a gateway. The address server performs mapping of the coordinates to an address. The service provider provides the address to the terminal that requests the service. However, according to an embodiment of the present invention, a telecommunication carrier has a location information server and an address server and can provide a service using the location information server and the address server of the telecommunication carrier. Accordingly, address information capable of being used directly in the application server can be transferred to the application server in network through the gateway.

Therefore, according to an embodiment of the present invention, the application server that provides an address service calls a Geocoding web service and uses a function of the gateway, so that it is possible to efficiently provide the service.

According to the present invention, the service in a mobile terminal of a user is initiated by requesting the service by using a short messaging service (SMS), a multimedia messaging service (MMS), or a wireless application protocol (WAP). When the user requests an application server for the address of the terminal, the application server calls the geocoding web service by inputting the terminal number and a response time for request. An open service gateway obtains the location corresponding to the terminal number from a location information server. The gateway transmits the location to an address server and obtains the address information of the terminal. The application server transmits the address information received from the gateway to the terminal that requests the service. In order to describe the invention briefly, a description of technical terms that those of ordinary skill in the art can understand easily is omitted.

As described above, unlike a conventional location information service providing model where a service provider has an application server which receives coordinates of latitude and longitude of a terminal and an address server which performs mapping of the coordinates of latitude and longitude to the address in order to provide the address to the terminal that requests the address service, in a system which provides an address service using a Geocoding API in an open service platform and a method thereof according to the present invention, a telecommunication carrier has a location information server and an address server, and a gateway and an application server can communicate with each other using a standard geocoding API. The address server performs mapping of the location received from the location information server to the address, and the gateway transmits the address to the application server. As a result, each service provider need not have its own address server, and the service provider can provide the address information received from the gateway to a user.

In addition, a service developer can develop various additional services associated with location without using geographic coordinates of latitude and longitude.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A gateway which provides an address using a geocoding API (application programming interface) in an open service platform, comprising:
a terminal address web module which is connected to an application server;
a main module which performs main processing and has a function of an RMI (remote method invocation) server;
a terminal address management unit which performs a geocoding function; and
a location management unit which obtains location information and address information of a mobile terminal according to a request from the terminal address management unit to provide the information to the application server.

2. The gateway of claim 1, wherein the terminal address web module performs data communication with the application server using the geocoding API.

3. The gateway of claim 1, wherein the location management unit comprises:
an MLP (mobile location protocol) adaptor which obtains coordinates of latitude and longitude of the mobile terminal; and
an OpenLS adaptor which obtains a result of mapping of the coordinates of latitude and longitude to the address.

4. An open service system which provides an address using a geocoding API (application programming interface) in an open service platform, comprising:
an application server which performs a logic operation of an address service and performs a function of a web server;
a location information server which provides location information of a mobile terminal;
an address server which provides address information corresponding to the location information; and
a service gateway which accesses the location information server and the address server to provide the address information to the application server according to a request from the application server.

5. The open service system of claim 4, wherein the service gateway performs data communication with the application server using the geocoding API.

6. The open service system of claim 4, wherein the service gateway exchanges the request and response messages for the location information of the mobile terminal with the location information server using an MLP.

7. The open service system of claim 4, wherein the service gateway exchanges the request and response messages for the address information corresponding to the location information of the mobile terminal with the address server using an OpenLS (openGIS location service).

8. The open service system of claim 4, wherein the mobile terminal requests address information by using SMS (short messaging service), MMS (multimedia messaging service), or WAP (wireless application protocol) to the application server.

9. The open service system of claim 4, wherein the location information server and the address server belong to the same mobile communication network of the same service provider.
